(19) United States
(12) Patent Application Publication
(10) Pub. No.: US 2020/0213402 A1
(43) Pub. Date: Jul. 2, 2020

(54) CLEANING ROBOT, COMMUNICATION METHOD, DEVICE AND SYSTEM THEREOF, AND MOBILE TERMINAL

(71) Applicants: JIANGSU MIDEA CLEANING APPLIANCES CO., LTD., Suzhou (CN); MIDEA GROUP CO., LTD., Foshan (CN)

(72) Inventors: Wei LI, Suzhou (CN); Dianhao Zhang, Suzhou (CN); Ke Li, Suzhou (CN)

(21) Appl. No.: 16/721,916

(22) Filed: Dec. 20, 2019

(30) Foreign Application Priority Data
Dec. 26, 2018 (CN) 201811598712.2

(51) Int. Cl. H04L 29/08; H04W 4/80; H04W 76/14; H04W 76/18; A47L 11/40

(52) U.S. Cl. CPC H04L 67/141; H04L 67/16; H04W 4/80; A47L 2201/00; H04W 76/18; A47L 11/4011; H04W 76/14

(57) ABSTRACT

Provided are a cleaning robot, communication method, device and system for a cleaning robot, and a mobile terminal. The communication method includes: receiving an IP address of the cleaning robot broadcasted outwards from the cleaning robot, and determining whether a mobile terminal and the cleaning robot are connected to a same local area network according to the IP address of the cleaning robot, if yes, establishing a communication connection between the mobile terminal and the cleaning robot in the local area network according to the IP address of the cleaning robot, if no, establishing the communication connection between the mobile terminal and the cleaning robot via a wide area network server. The present communication method is able to establish a communication connection between the mobile terminal and the cleaning robot in a local area network.

### CROSS-REFERENCES TO RELATED APPLICATIONS

The present application is based on and claims priority to Chinese patent application number 201811598712.2, filed on Dec. 26, 2018, the entire disclosure of which is hereby incorporated by reference.

### FIELD

The present disclosure relates to a field of communication technology, and particular to a communication method for a cleaning robot, a communication device for a cleaning robot, a mobile terminal, a cleaning robot, a communication system for a cleaning robot, an electronic device and a non-transitory computer readable storage medium.

### BACKGROUND

Currently, interaction between the cleaning robot and an application (APP) of a mobile phone is normally established by a WebSocket (a full-duplex communication protocol based on transmission control protocol (TCP)) persistent connection in the wide area network (WAN), that is, a WebSocket persistent connection is established between a server and the cleaning robot via the WAN, and a WebSocket persistent connection is established between the APP of the mobile phone and the server via the WAN. In this way, an instruction is sent from the APP of the mobile phone to the cleaning robot via a transit server, and the connection relationship thereof is shown in FIG. 1.

However, the server transfer of the instruction from the APP of the mobile phone to the cleaning robot may cause a delay, and delay time depends on the network bandwidth, the routing forwarding and the server response time, so that the instruction execution efficiency may decrease. If the delay is serious, it will negatively affect user experience.

### SUMMARY

The present disclosure seeks to solve at least one of the problems that exist in the related art to at least some extent.

Embodiments of the present disclosure is to provide a communication method for a cleaning robot, being able to establish a communication connection between a mobile terminal and the cleaning robot in a local area network, which may greatly improve the efficiency for the cleaning robot to execute an instruction from the mobile terminal and thus improves the user experience.

Embodiments of the present disclosure is to provide another communication method for a cleaning robot.

Embodiments of the present disclosure is to provide a communication device for a cleaning robot.

Embodiments of the present disclosure is to provide another communication device for a cleaning robot.

Embodiments of the present disclosure is to provide a mobile terminal.

Embodiments of the present disclosure is to provide a cleaning robot.

Embodiments of the present disclosure is to provide a communication system for a cleaning robot.

Embodiments of the present disclosure is to provide an electronic device.

Embodiments of the present disclosure is to provide a non-transitory computer readable storage medium.

Embodiments of the present disclosure provide a communication method for a cleaning robot, including: receiving an IP address of the cleaning robot broadcasted outwards from the cleaning robot, and determining whether a mobile terminal and the cleaning robot are connected to a same local area network according to the IP address of the cleaning robot, if yes, establishing a communication connection between the mobile terminal and the cleaning robot in the local area network according to the IP address of the cleaning robot, if no, establishing the communication connection between the mobile terminal and the cleaning robot via a wide area network server.

With the communication method for a cleaning robot according to the embodiments of the present disclosure, the IP address of the cleaning robot broadcasted outwards from the cleaning robot is received first, and it is determined whether the mobile terminal and the cleaning robot are connected to the same local area network according to the IP address of the cleaning robot, if yes, the communication connection between the mobile terminal and the cleaning robot is established in the local area network according to the IP address of the cleaning robot; if no, the communication connection between the mobile terminal and the cleaning robot is established via the wide area network server. Therefore, the communication connection between the mobile terminal and the cleaning robot can be established in the local area network which may greatly improve the efficiency for the cleaning robot to execute an instruction from the mobile terminal and thus improves the user experience.

In addition, the communication method for the cleaning robot according to the above embodiment of the present disclosure may further have the following additional embodiments.

In an embodiment of the present disclosure, receiving the IP address of the cleaning robot broadcasted outwards from the cleaning robot includes: receiving the IP address of the cleaning robot broadcasted outwards from the cleaning robot with a user datagram protocol (UDP).

In an embodiment of the present disclosure, determining whether the mobile terminal and the cleaning robot are connected to the same local area network according to the IP address of the cleaning robot includes: acquiring an IP address of the mobile terminal, determining whether the IP address of the cleaning robot and the IP address of the mobile terminal are in a same local area network segment, if yes, determining that the mobile terminal and the cleaning robot are connected to the same local area network, if no, determining that the mobile terminal and the cleaning robot are not connected to the same local area network.

In an embodiment of the present disclosure, the communication method further includes: if no, controlling the mobile terminal to activate a Bluetooth device to perform a Bluetooth pairing with the cleaning robot, if the pairing is successful, establishing the communication connection between the mobile terminal and the cleaning robot via Bluetooth, if the pairing is not successful, establishing the communication connection between the mobile terminal and the cleaning robot via the wide area network server.

Embodiments of the present disclosure provide another communication method for a cleaning robot, the cleaning robot is connected to a local area network, and the communication method includes: broadcasting an IP address of the cleaning robot outwards to enable the mobile terminal to establish a communication connection with the cleaning robot in the local area network according to the IP address of the cleaning robot.

With the communication method for a cleaning robot according to the embodiments of the present disclosure, when the cleaning robot is connected to the local area network, the IP address of the cleaning robot is broadcasted outwards to enable the mobile terminal to establish the communication connection with the cleaning robot in the local area network according to the IP address of the cleaning robot. Therefore, by establishing the communication connection between the mobile terminal and the cleaning robot in the local area network, the efficiency for the cleaning robot to execute an instruction from the mobile terminal may be greatly improved and thus the user experience may be improved.

Embodiments of the present disclosure provide a communication device for a cleaning robot, including: a receiving device, configured to receive an IP address of the cleaning robot broadcasted outwards from the cleaning robot, a determining device, configured to determine whether a mobile terminal and the cleaning robot are connected to a same local area network according to the IP address of the cleaning robot, a connecting device, configured to establish a communication connection between the mobile terminal and the cleaning robot in the local area network according to the IP address of the cleaning robot if it is determined by the determining device that the mobile terminal and the cleaning robot are connected to the same local area network, further configured to establish the communication connection between the mobile terminal and the cleaning robot via a wide area network server if it is determined by the determining device that the mobile terminal and the cleaning robot are not connected to the same local area network.

With the communication device for a cleaning robot according to the embodiments of the present disclosure, the IP address of the cleaning robot broadcasted outwards from the cleaning robot is received by the receiving device, and the determining device determines whether the mobile terminal and the cleaning robot are connected to the same local area network according to the IP address of the cleaning robot. When it is determined by the determining device that the mobile terminal and the cleaning robot are connected to the same local area network, the connecting device establishes the communication connection between the mobile terminal and the cleaning robot in the local area network according to the IP address of the cleaning robot. When it is determined by the determining device that the mobile terminal and the cleaning robot are not connected to the same local area network, the connecting device establishes the communication connection between the mobile terminal and the cleaning robot via the wide area network server. Therefore, the communication connection between the mobile terminal and the cleaning robot can be established in the local area network which may greatly improve the efficiency for the cleaning robot to execute an instruction from the mobile terminal and thus improves the user experience.

In addition, the communication method for the cleaning robot according to the above embodiment of the present disclosure may further have the following additional embodiments.

In an embodiment of the present disclosure, the receiving device is configured to: receive the IP address of the cleaning robot broadcasted outwards from the cleaning robot with a user datagram protocol (UDP).

In an embodiment of the present disclosure, the determining device is configured to: acquire an IP address of the mobile terminal, determine whether the IP address of the cleaning robot and the IP address of the mobile terminal are in a same local area network segment, if yes, determine that the mobile terminal and the cleaning robot are connected to the same local area network, if no, determine that the mobile terminal and the cleaning robot are not connected to the same local area network.

In an embodiment of the present disclosure, the connecting device is configured to: control the mobile terminal to activate a Bluetooth device to perform a Bluetooth pairing with the cleaning robot if it is determined by the determining device that the mobile terminal and the cleaning robot are not connected to the same local area network, establish the communication connection between the mobile terminal and the cleaning robot via Bluetooth if the pairing is successful, establish the communication connection between the mobile terminal and the cleaning robot via the wide area network server if the pairing is not successful.

Embodiments of the present disclosure provide another communication device for a cleaning robot, including: a broadcasting device, configured to broadcast an IP address of the cleaning robot outwards when the cleaning robot is connected to a local area network to enable the mobile terminal to establish a communication connection with the cleaning robot in the local area network according to the IP address of the cleaning robot.

With the communication device for a cleaning robot according to the embodiments of the present disclosure, when the cleaning robot is connected to the local area network, the broadcasting device broadcasts the IP address of the cleaning robot outwards to enable the mobile terminal to establish the communication connection with the cleaning robot in the local area network according to the IP address of the cleaning robot. Therefore, by establishing the communication connection between the mobile terminal and the cleaning robot in the local area network, the efficiency for the cleaning robot to execute an instruction from the mobile terminal may be greatly improved and thus the user experience may be improved.

Embodiments of the present disclosure provide a mobile terminal, including a communication device for a cleaning robot as described in the embodiments of the present disclosure.

With the mobile terminal according to the embodiments of the present disclosure, by using the communication device for a cleaning robot as described in the embodiments of the present disclosure, the communication connection between the mobile terminal and the cleaning robot can be established in the local area network which may greatly improve the efficiency for the cleaning robot to execute an instruction from the mobile terminal and thus improves the user experience.

Embodiments of the present disclosure provide a cleaning robot, including a communication device for a cleaning robot as described in the embodiments of the present disclosure.

With the cleaning robot according to the embodiments of the present disclosure, by using the communication device for a cleaning robot as described in the embodiments of the present disclosure, the communication connection between the mobile terminal and the cleaning robot can be established in the local area network, which may greatly improve the efficiency for the cleaning robot to execute an instruction from the mobile terminal and thus improves the user experience.

Embodiments of the present disclosure provide a communication system for a cleaning robot, including a mobile terminal as described in the embodiments of the present disclosure and a cleaning robot as described in the embodiments of the present disclosure.

With the communication system according to the embodiments of the present disclosure, by using the mobile terminal as described in the embodiments of the present disclosure and the cleaning robot as described in the embodiments of the present disclosure, the communication connection between the mobile terminal and the cleaning robot can be established in the local area network which may greatly improve the efficiency for the cleaning robot to execute an instruction from the mobile terminal and thus improves the user experience.

Embodiments of the present disclosure provide an electronic device, including: a processor, and a memory having stored therein computer programs that, when executed by the processor, causes the processor to perform a communication method for a cleaning robot as described in the embodiments of the present disclosure or a communication method for a cleaning robot as described in the embodiments of the present disclosure.

With the electronic device according to the embodiments of the present disclosure, the processor executes the computer programs stored in the memory, and the communication connection between the mobile terminal and the cleaning robot can be established in the local area network, which may greatly improve the efficiency for the cleaning robot to execute an instruction from the mobile terminal and thus improves the user experience.

Embodiments of the present disclosure provide a non-transitory computer readable storage medium having stored therein a computer program that, when executed by a processor, causes the processor to perform a communication method for a cleaning robot as described in the embodiments of the present disclosure or a communication method for a cleaning robot as described in the embodiments of the present disclosure.

With the non-transitory computer readable storage medium according to the embodiments of the present disclosure, by executing the computer program stored therein, the communication connection between the mobile terminal and the cleaning robot can be established in the local area network, which may greatly improve the efficiency for the cleaning robot to execute an instruction from the mobile terminal and thus improves the user experience.

### BRIEF DESCRIPTION OF THE DRAWINGS

Embodiments of the present disclosure will become apparent and more readily appreciated from the following descriptions made with reference to the drawings, in which:

FIG. 1 is a schematic diagram of communication between a mobile phone APP and a cleaning robot in the related art;

FIG. 2 is a flow chart of a communication method for a cleaning robot according to an embodiment of the present disclosure;

FIG. 3 is a flow chart of a communication method for a cleaning robot according to another embodiment of the present disclosure;

FIG. 4 is a flow chart of a communication method for a cleaning robot according to still another embodiment of the present disclosure;

FIG. 5 is a block diagram of a communication device for a cleaning robot according to an embodiment of the present disclosure; and

FIG. 6 is a block diagram of a communication device for a cleaning robot according to another embodiment of the present disclosure.

### DETAILED DESCRIPTION OF THE INVENTION

Exemplary embodiments will be described in detail herein, and examples thereof are illustrated in accompanying drawings. Throughout figures referred by the following description, the same reference number in different figures indicates the same or similar elements. The embodiments described herein with reference to drawings are explanatory, and used to generally describe the present disclosure, which shall not be construed to limit the present disclosure.

A communication method for a cleaning robot, a communication device for a cleaning robot, a mobile terminal, a cleaning robot, a communication system for a cleaning robot, an electronic device and a non-transitory computer readable storage medium according to embodiments of the present disclosure are described below with reference to the drawings.

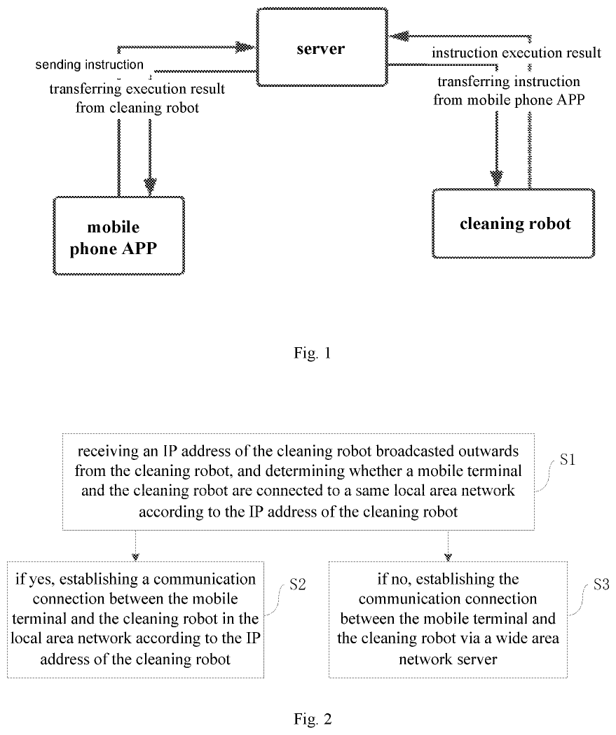

FIG. 2 is a flow chart of a communication method for a cleaning robot according to an embodiment of the present disclosure.

As shown in FIG. 2, the communication method for a cleaning robot includes following steps.

In S1, an IP address of the cleaning robot broadcasted outwards from the cleaning robot is received, and it is determined whether a mobile terminal and the cleaning robot are connected to a same local area network according to the IP address of the cleaning robot.

In an embodiment of the present disclosure, a step of receiving the IP address of the cleaning robot broadcasted outwards from the cleaning robot includes receiving the IP address of the cleaning robot broadcasted outwards from the cleaning robot with a user datagram protocol (UDP).

Specifically, after the cleaning robot is powered on, a built-in Wireless Fidelity (WiFi) device can automatically search for a nearby WiFi signal, i.e., a LAN signal. Moreover, when the cleaning robot is powered on (used) for the first time, it can be connected to the network, for example, access to a home area network (i.e., a home WiFi) under control of a cleaning robot APP of the mobile terminal.

When the cleaning robot accesses the home local area network (target network), the built-in WiFi device of the cleaning robot can utilize a port (for example, port 2088) in the home local area network to broadcast the IP address of the cleaning robot with the UDP.

The cleaning robot APP installed in the mobile terminal can automatically search for a nearby broadcasting signal after being activated. When the IP address of the cleaning robot broadcasted from the cleaning robot with the UDP is received, it is determined whether the mobile terminal and the cleaning robot are connected to the same local area network according to the IP address of the cleaning robot.

It should be noted that the WiFi signal described in this embodiment can be sent by a router.

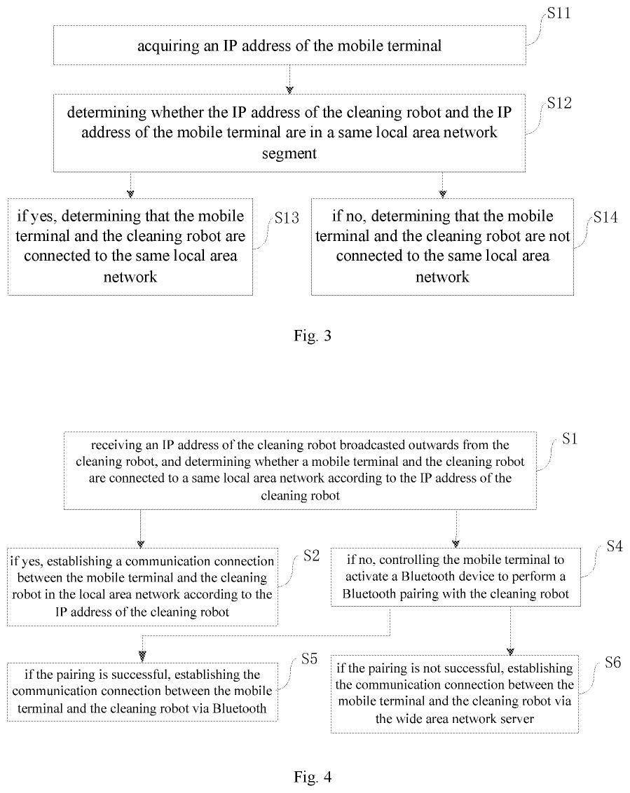

In an embodiment of the present disclosure, as shown in FIG. 3, a step of determining whether the mobile terminal and the cleaning robot are connected to the same local area network according to the IP address of the cleaning robot may include the following steps.

In S11, an IP address of the mobile terminal is acquired.

Specifically, when the cleaning robot APP as described above receives the IP address of the cleaning robot broadcasted by the cleaning robot, an IP address of the mobile terminal can be acquired by using an application programming interface (API) provided by the mobile terminal.

In S12, it is determined whether the IP address of the cleaning robot and the IP address of the mobile terminal are in a same local area network segment.

In S13, if yes, it is determined that the mobile terminal and the cleaning robot are connected to the same local area network.

In S14, if no, it is determined that the mobile terminal and the cleaning robot are not connected to the same local area network.

Specifically, after the cleaning robot APP as described above acquires the IP address of the mobile terminal, the IP address of the cleaning robot can be compared with the IP address of the mobile terminal to determine whether the two IP addresses are in the same LAN segment, and if yes, it is determined that the mobile terminal and the cleaning robot are connected to the same local area network (the target network); if no, it is determined that the mobile terminal and the cleaning robot are not connected to the same local area network. It should be noted that each network segment of the LAN is different to others.

In S2, if yes, a communication connection between the mobile terminal and the cleaning robot is established in the local area network according to the IP address of the cleaning robot.

In S3, if no, the communication connection between the mobile terminal and the cleaning robot is established via a wide area network server.

Specifically, when the cleaning robot APP determines that the mobile terminal and the cleaning robot are connected to the same local area network (the target network), the communication connection between the mobile terminal and the cleaning robot may be established in the local area network according to the IP address of the cleaning robot, i.e., a socket connection is established. When the cleaning robot APP determines that the mobile terminal and the cleaning robot are not connected to the same local area network (the target network), the communication connection between the mobile terminal and the cleaning robot may be established via the wide area network server, that is the mobile terminal is controlled to establish a communication connection to a server of the cleaning robot to communicate with the cleaning robot through the server of the cleaning robot. Therefore, the local area network may be a priority to be used when establishing the communication between the mobile terminal and the cleaning robot. If the local area network is not available, the technology of the wide area network communication may be used. In this way, the efficiency for the cleaning robot to execute an instruction from the mobile terminal may be greatly improved and thus the user experience may be improved.

Another embodiment of the present disclosure, as shown in FIG. 4, the communication method for a cleaning robot as described above may further include the following steps.

In S4, if no, the mobile terminal is controlled to activate a Bluetooth device to perform a Bluetooth pairing with the cleaning robot.

In S5, if the pairing is successful, the communication connection between the mobile terminal and the cleaning robot is established via Bluetooth.

In S6, if the pairing is not successful, the communication connection between the mobile terminal and the cleaning robot is established via the wide area network server.

Specifically, when the cleaning robot APP determines that the mobile terminal and the cleaning robot are not connected to the same local area network (the target network), the mobile terminal is controlled to activate the Bluetooth device. After the Bluetooth device is activated, the mobile terminal searches a Bluetooth signal of a preset range via the Bluetooth device. If a Bluetooth signal of the cleaning robot is found, the mobile terminal performs the Bluetooth pairing with the cleaning robot. If the pairing is successful, the cleaning robot APP may establish the communication connection between the mobile terminal and the cleaning robot via Bluetooth. If the pairing is not successful, the cleaning robot APP may establish the communication connection between the mobile terminal and the cleaning robot via the wide area network server. Therefore, the efficiency for the cleaning robot to execute an instruction from the mobile terminal may be greatly improved and thus the user experience may be improved.

In other embodiments of the present disclosure, when it is determined that the mobile terminal and the cleaning robot are not connected to the same local area network, the mobile terminal may establish the communication connection between the mobile terminal and the cleaning robot by other means, for example, an infrared communication and a near field communication (NFC).

In conclusion, with the communication method for a cleaning robot according to the embodiments of the present disclosure, the IP address of the cleaning robot broadcasted outwards from the cleaning robot is received first, and it is determined whether the mobile terminal and the cleaning robot are connected to the same local area network according to the IP address of the cleaning robot, if yes, the communication connection between the mobile terminal and the cleaning robot is established in the local area network according to the IP address of the cleaning robot; if no, the communication connection between the mobile terminal and the cleaning robot is established via the wide area network server. Therefore, the communication connection between the mobile terminal and the cleaning robot can be established in the local area network which may greatly improve the efficiency for the cleaning robot to execute an instruction from the mobile terminal and thus improves the user experience.

Embodiments of the present disclosure provide another communication method for a cleaning robot, the cleaning robot is connected to a local area network, and the communication method includes: broadcasting an IP address of the cleaning robot outwards to enable the mobile terminal to establish a communication connection with the cleaning robot in the local area network according to the IP address of the cleaning robot.

It should be noted that details not disclosed in the communication method for a cleaning robot in the embodiment of the present disclosure may refer to the details disclosed in the communication method of a cleaning robot in the embodiments as shown in FIGS. 2 to 4, and thus are not described herein again.

In conclusion, with the communication method for a cleaning robot according to the embodiment of the present disclosure, when the cleaning robot is connected to the local area network, the IP address of the cleaning robot is broadcasted outwards to enable the mobile terminal to establish the communication connection with the cleaning robot in the local area network according to the IP address of the cleaning robot. Therefore, by establishing the communication connection between the mobile terminal and the cleaning robot in the local area network, the efficiency for the cleaning robot to execute an instruction from the mobile terminal may be greatly improved and thus the user experience may be improved.

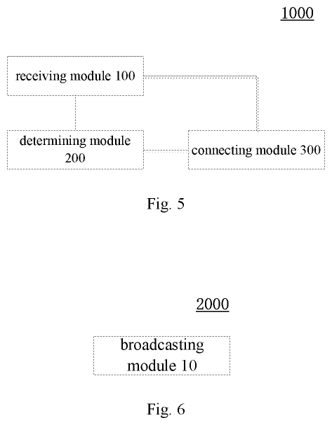

FIG. 5 is a block diagram of a communication device for a cleaning robot according to an embodiment of the present disclosure.

As shown in FIG. 5, the communication device 1000 for a cleaning robot according to the embodiment of the present disclosure includes a receiving device 100, a determining device 200 and a connecting device 300.

Specifically, the receiving device 100 is configured to receive an IP address of the cleaning robot broadcasted outwards from the cleaning robot.

The determining device 200 is configured to determine whether a mobile terminal and the cleaning robot are connected to a same local area network according to the IP address of the cleaning robot.

The connecting device 300 is configured to establish a communication connection between the mobile terminal and the cleaning robot in the local area network according to the IP address of the cleaning robot if it is determined by the determining device 200 that the mobile terminal and the cleaning robot are connected to the same local area network.

The connecting device 300 is further configured to establish the communication connection between the mobile terminal and the cleaning robot via a wide area network server if it is determined by the determining device 200 that the mobile terminal and the cleaning robot are not connected to the same local area network.

In an embodiment of the present disclosure, the receiving device 100 is configured to receive the IP address of the cleaning robot broadcasted outwards from the cleaning robot with a user datagram protocol (UDP).

In an embodiment of the present disclosure, the determining device 200 is configured to: acquire an IP address of the mobile terminal, determine whether the IP address of the cleaning robot and the IP address of the mobile terminal are in a same local area network segment, if yes, determine that the mobile terminal and the cleaning robot are connected to the same local area network, if no, determine that the mobile terminal and the cleaning robot are not connected to the same local area network.

In an embodiment of the present disclosure, the connecting device 300 is configured to: control the mobile terminal to activate a Bluetooth device to perform a Bluetooth pairing with the cleaning robot if it is determined by the determining device that the mobile terminal and the cleaning robot are not connected to the same local area network, establish the communication connection between the mobile terminal and the cleaning robot via Bluetooth if the pairing is successful, establish the communication connection between the mobile terminal and the cleaning robot via the wide area network server if the pairing is not successful.

It should be noted that details not disclosed in the communication device for a cleaning robot in the embodiment of the present disclosure may refer to the details disclosed in the communication method of a cleaning robot in the embodiments as shown in FIGS. 2 to 4, and thus are not described herein again.

In conclusion, with the communication device for a cleaning robot according to the embodiments of the present disclosure, the IP address of the cleaning robot broadcasted outwards from the cleaning robot is received by the receiving device, and the determining device determines whether the mobile terminal and the cleaning robot are connected to the same local area network according to the IP address of the cleaning robot. When it is determined by the determining device that the mobile terminal and the cleaning robot are connected to the same local area network, the connecting device establishes the communication connection between the mobile terminal and the cleaning robot in the local area network according to the IP address of the cleaning robot. When it is determined by the determining device that the mobile terminal and the cleaning robot are not connected to the same local area network, the connecting device establishes the communication connection between the mobile terminal and the cleaning robot via the wide area network server. Therefore, the communication connection between the mobile terminal and the cleaning robot can be established in the local area network which may greatly improve the efficiency for the cleaning robot to execute an instruction from the mobile terminal and thus improves the user experience.

FIG. 6 is a block diagram of a communication device for a cleaning robot according to another embodiment of the present disclosure.

As shown in FIG. 6, the communication device 2000 for a cleaning robot according to the embodiment of the present disclosure includes a broadcasting device 10.

Specifically, the broadcasting device 10 is configured to broadcast an IP address of the cleaning robot outwards when the cleaning robot is connected to a local area network to enable the mobile terminal to establish a communication connection with the cleaning robot in the local area network according to the IP address of the cleaning robot.

It should be noted that details not disclosed in the communication device for a cleaning robot in the embodiment of the present disclosure may refer to the details disclosed in the communication method of a cleaning robot in the embodiments as shown in FIGS. 2 to 4, and thus are not described herein again.

In conclusion, with the communication device for a cleaning robot according to the embodiments of the present disclosure, when the cleaning robot is connected to the local area network, the broadcasting device broadcasts the IP address of the cleaning robot outwards to enable the mobile terminal to establish the communication connection with the cleaning robot in the local area network according to the IP address of the cleaning robot. Therefore, by establishing the communication connection between the mobile terminal and the cleaning robot in the local area network, the efficiency for the cleaning robot to execute an instruction from the mobile terminal may be greatly improved and thus the user experience may be improved.

In order to realize the above embodiments, the present disclosure further provides a mobile terminal, including a communication device for a cleaning robot as described in the embodiment as shown in FIG. 4.

With the mobile terminal according to the embodiments of the present disclosure, by using the communication device for a cleaning robot as described in the embodiments as shown in FIG. 4, the communication connection between the mobile terminal and the cleaning robot can be established in the local area network which may greatly improve the efficiency for the cleaning robot to execute an instruction from the mobile terminal and thus improves the user experience.

In order to realize the above embodiments, the present disclosure further provides a cleaning robot, including a communication device for a cleaning robot as described in the embodiments as shown in FIG. 5.

With the cleaning robot according to the embodiments of the present disclosure, by using the communication device for a cleaning robot as described in the embodiments as shown in FIG. 5, the communication connection between the mobile terminal and the cleaning robot can be established in the local area network, which may greatly improve the efficiency for the cleaning robot to execute an instruction from the mobile terminal and thus improves the user experience.

In order to realize the above embodiments, the present disclosure further provides a communication system for a cleaning robot, including a mobile terminal and a cleaning robot.

With the communication system according to the embodiments of the present disclosure, by using the mobile terminal as described in the embodiments of the present disclosure and the cleaning robot as described in the embodiments of the present disclosure, the communication connection between the mobile terminal and the cleaning robot can be established in the local area network which may greatly improve the efficiency for the cleaning robot to execute an instruction from the mobile terminal and thus improves the user experience.

In order to realize the above embodiments, the present disclosure further provides an electronic device, including: a processor, and a memory having stored therein computer programs that, when executed by the processor, causes the processor to perform a communication method for a cleaning robot as described in the above embodiments of the present disclosure.

With the electronic device according to the embodiments of the present disclosure, the processor executes the computer programs stored in the memory, and the communication connection between the mobile terminal and the cleaning robot can be established in the local area network, which may greatly improve the efficiency for the cleaning robot to execute an instruction from the mobile terminal and thus improves the user experience.

In order to realize the above embodiments, the present disclosure further provides a non-transitory computer readable storage medium having stored therein a computer program that, when executed by a processor, causes the processor to perform a communication method for a cleaning robot as described in the above embodiments of the present disclosure.

With the non-transitory computer readable storage medium according to the embodiments of the present disclosure, by executing the computer program stored therein, the communication connection between the mobile terminal and the cleaning robot can be established in the local area network, which may greatly improve the efficiency for the cleaning robot to execute an instruction from the mobile terminal and thus improves the user experience.

In the specification, it is to be understood that terms such as “central”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial” and “circumferential” should be construed to refer to the orientation as then described or as shown in the drawings under discussion. These relative terms are for convenience of description and do not require that the present disclosure be constructed or operated in a particular orientation, and thus shall not be construed to limit the present disclosure.

In addition, terms such as “first” and “second” are used herein for purposes of description and are not intended to indicate or imply relative importance or significance or to imply the number of indicated embodiments. Thus, the feature defined with “first” and “second” may include one or more of this feature. In the description of the present disclosure, unless specified otherwise, “a plurality of” means two or more than two.

In the present disclosure, unless specified or limited otherwise, the terms “mounted”, “connected”, “coupled”, “fixed” and the like are used broadly, and may be, for example, fixed connections, detachable connections, or integral connections; may also be mechanical or electrical connections; may also be direct connections or indirect connections via intervening structures; may also be inner communications of two elements.

In the description, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on”, “above” or “on top of” a second feature may include an embodiment in which the first feature is right or obliquely “on”, “above” or “on top of” the second feature, or just means that the first feature is at a height higher than that of the second feature; while a first feature “below”, “under” or “on bottom of” a second feature may include an embodiment in which the first feature is right or obliquely “below”, “under” or “on bottom of” the second feature, or just means that the first feature is at a height lower than that of the second feature.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. Thus, the appearances of above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples described in the specification, as well as features of embodiments or examples.

1. A communication method for a cleaning robot, comprising:
receiving an IP address of cleaning robot broadcasted outwards from the cleaning robot, and determining whether a mobile terminal and the cleaning robot are connected to a same local area network according to the IP address of the cleaning robot,
if yes, establishing a communication connection between the mobile terminal and the cleaning robot in the local area network according to the IP address of the cleaning robot, and
if no, establishing the communication connection between the mobile terminal and the cleaning robot via a wide area network server.

2. The communication method according to claim 1, wherein receiving the IP address of the cleaning robot broadcasted outwards from the cleaning robot comprises:
receiving the IP address of the cleaning robot broadcasted outwards from the cleaning robot with a user datagram protocol (UDP).

3. The communication method according to claim 1, wherein determining whether the mobile terminal and the cleaning robot are connected to the same local area network according to the IP address of the cleaning robot comprises:
acquiring an IP address of the mobile terminal,
determining whether the IP address of the cleaning robot and the IP address of the mobile terminal are in a same local area network segment,
if yes, determining that the mobile terminal and the cleaning robot are connected to the same local area network,
if no, determining that the mobile terminal and the cleaning robot are not connected to the same local area network.

4. The communication method according to claim 1, further comprising:
if no, controlling the mobile terminal to activate a Bluetooth device to perform a Bluetooth pairing with the cleaning robot,
if the Bluetooth pairing is successful, establishing the communication connection between the mobile terminal and the cleaning robot via Bluetooth,
if the Bluetooth pairing is not successful, establishing the communication connection between the mobile terminal and the cleaning robot via the wide area network server.

5. A communication method for a cleaning robot, the cleaning robot being connected to a local area network, comprising:
broadcasting an IP address of the cleaning robot outwards to enable the mobile terminal to establish a communication connection with the cleaning robot in the local area network according to the IP address of the cleaning robot.

6. A communication device for a cleaning robot, comprising:
a receiving device, configured to receive an IP address of cleaning robot broadcasted outwards from the cleaning robot,
a determining device, configured to determine whether a mobile terminal and the cleaning robot are connected to a same local area network according to the IP address of the cleaning robot,
a connecting device,
configured to establish a communication connection between the mobile terminal and the cleaning robot in the local area network according to the IP address of the cleaning robot if it is determined by the determining device that the mobile terminal and the cleaning robot are connected to the same local area network, and
further configured to establish the communication connection between the mobile terminal and the cleaning robot via a wide area network server if it is determined by the determining device that the mobile terminal and the cleaning robot are not connected to the same local area network.

7. The communication device according to claim 6, wherein the receiving device is configured to:
receive the IP address of the cleaning robot broadcasted outwards from the cleaning robot with a user datagram protocol (UDP).

8. The communication device according to claim 6, wherein the determining device is configured to:
acquire an IP address of the mobile terminal,
determine whether the IP address of the cleaning robot and the IP address of the mobile terminal are in a same local area network segment,
if yes, determine that the mobile terminal and the cleaning robot are connected to the same local area network,
if no, determine that the mobile terminal and the cleaning robot are not connected to the same local area network.

9. The communication device according to claim 6, wherein the connecting device is configured to:
control the mobile terminal to activate a Bluetooth device to perform a Bluetooth pairing with the cleaning robot if it is determined by the determining device that the mobile terminal and the cleaning robot are not connected to the same local area network,
establish the communication connection between the mobile terminal and the cleaning robot via Bluetooth if the Bluetooth pairing is successful,
establish the communication connection between the mobile terminal and the cleaning robot via the wide area network server if the Bluetooth pairing is not successful.

10. A communication device for a cleaning robot, comprising:
a broadcasting device, configured to broadcast an IP address of the cleaning robot outwards when the cleaning robot is connected to a local area network to enable the mobile terminal to establish a communication connection with the cleaning robot in the local area network according to the IP address of the cleaning robot.

11. A mobile terminal, comprising:
a communication device for a cleaning robot, comprising:
a receiving device, configured to receive an IP address of cleaning robot broadcasted outwards from the cleaning robot,
a determining device, configured to determine whether a mobile terminal and the cleaning robot are connected to a same local area network according to the IP address of the cleaning robot,
a connecting device,
configured to establish a communication connection between the mobile terminal and the cleaning robot in the same local area network according to the IP address of the cleaning robot if it is determined by the determining device that the mobile terminal and the cleaning robot are connected to the same local area network, and
further configured to establish the communication connection between the mobile terminal and the cleaning robot via a wide area network server if it is determined by the determining device that the mobile terminal and the cleaning robot are not connected to the same local area network.

12. A cleaning robot, comprising a communication device for a cleaning robot according to claim 10.

13. A communication device for a cleaning robot, comprising a mobile terminal according to claim 11.

14. (canceled)

15. A non-transitory computer readable storage medium having stored therein a computer program that, when executed by a processor, causes the processor to perform a communication method for a cleaning robot, comprising:
receiving an IP address of cleaning robot broadcasted outwards from the cleaning robot, and determining whether a mobile terminal and the cleaning robot are connected to a same local area network according to the IP address of the cleaning robot,
if yes establishing a communication connection between the mobile terminal and the cleaning robot in the same local area network according to the IP address of the cleaning robot, and
if no establishing the communication connection between the mobile terminal and the cleaning robot via a wide area network server.
